(19) United States
(12) Patent Application Publication
(10) Pub. No.: US 2013/0216873 A1
(43) Pub. Date: Aug. 22, 2013

(54) ELECTROCHEMICAL CELL HAVING AT LEAST ONE PRESSURE RELIEF MEANS

(71) Applicant: Tim Schaefer, Harztor (DE)

(72) Inventor: Tim Schaefer, Harztor (DE)

(73) Assignee: Li-Tec Battery GmbH, Kamenz (DE)

(21) Appl. No.: 13/817,341

(22) PCT Filed: Aug. 11, 2011
(86) PCT No.: PCT/EP2011/004047

§ 371 Date: Apr. 25, 2013

(30) Foreign Application Priority Data
Aug. 17, 2010 (DE) 10 2010 034 545.8

(51) Int. Cl. H01M 2/12

(52) U.S. Cl. CPC H01M 2/12
USPC 429/82

(57) ABSTRACT

An electrochemical cell has an energy unit (10) which has an electrode stack, at least one main lead (12, 14) which is connected to the electrode stack, and a casing (18) which at least partially surrounds the electrode stack; at least one frame element (16) which at least partially accommodates the energy unit (10); and at least one pressure-relief apparatus (32, 46). The casing (18) has a plurality of edge sections at the peripheral narrow sides of the electrochemical cell, wherein the at least one main lead (12, 14) extends at least partially out of the casing (18) in a first edge section and this first edge section of the casing (18) has a substantially fluid-tight first sealing seam (20, 22). In addition, the at least one frame element (16) has at least one first supporting web (34, 36) in the region of the first edge section of the casing (18), said supporting web being at a distance of a maximum of approximately 1 mm from the first sealing seam (20, 22) of the casing (18) and thereby preventing or at least making it difficult for this first sealing seam (20, 22) to tear open in the region of the at least one main lead (12, 14) in the event of an increase in the pressure and/or temperature in the interior of the cells.

The present invention relates to an electrochemical cell for a battery assembly, in particular an electrochemical cell having at least one pressure relief means.

Batteries (primary storage) and accumulators (secondary storage) composed of one or more storage cells which convert electrical energy into chemical energy in an electrochemical charge reaction between a cathode and an anode in or between an electrolyte and thus store same upon a charging current being applied and which convert chemical energy into electrical energy in an electrochemical discharge reaction upon an electrical consumer being connected are known as electrochemical energy storage apparatus. Primary storage devices are usually only charged once and disposed of after having been discharged whereas secondary storage devices allow a plurality of charging and discharging cycles (from a few 100 to more than 10,000). To be noted in conjunction hereto is that accumulators are also referred to as batteries, particularly in the automotive sector.

The present invention is described in conjunction with lithium ion batteries for supplying motor vehicle drives. It is pointed out that the invention can also be used independently of the chemistry and the design of the electrochemical cell and the battery and also independently of the type of drive supplied.

Electrochemical cells comprising an energy unit having an electrode stack, at least one current conductor connected to the electrode stack and a casing which at least partially encloses the electrode stack are known from the prior art. The casing is to prevent chemicals from leaking out of the electrode stack into the environment on the one hand and, on the other, to protect the components of the cell from undesired interactions with the environment, for example from water or water vapor.

Further prior art electrochemical cells are known in which such an energy unit is at least partially accommodated in at least one frame element. Reference is made to the applicant's post-published DE 10 2009 010 794 A1 and DE 10 2010 022 217 A1 as examples thereof. Such frame elements serve particularly in mechanically stabilizing the energy units, particularly when manufacturing a battery assembly comprising a plurality of electrochemical cells.

When damaged or even during normal operation given high external heat, the electrochemical cells, storage apparatus respectively, can become thermally overheated upon heavy load or overloading, for example in the case of overload or short circuit, which results in an increase in the cell's internal pressure which can lead to the cell and the housing bursting, igniting or exploding. There is particular risk especially with lithium or lithium ion batteries since these batteries contain liquid, flammable, organic electrolytes which can thereby leak.

Further different electrochemical cells are known in which a pressure relief means is provided to reduce such excess pressure within the energy unit. Such pressure relief means are designed for example as localized weakenings to the sealing seam, e.g. by means of inserted elements which have a lower melting point. Reference is made to KR 10 2009 0076343 A, US 2003/0148173 A1, U.S. Pat. No. 7,122,276 B2, US 2010/01 12436 A1 and WO 2009/078604 A2 as examples thereof.

A flat lithium ion battery design is known from DE 10 2007 063 193 A1 in which a housing frame comprising a pressure relief means in the form of a lateral rupture area surrounds an electrochemical cell so that in critical excess pressure situations, pressure and gas can be discharged to the outside from the sides.

The invention is based on the task of improving an electrochemical cell which enables safely reducing excess pressure within the energy unit when needed.

This object is achieved in accordance with the invention by the teaching of the independent claims. Preferred further developments of the invention constitute the subject matter of the subclaims.

The invention provides for an electrochemical cell comprising an energy unit, at least one frame element at least partially accommodating the energy unit and at least one pressure relief means for reducing excess pressure within the energy unit. The energy unit comprises an electrode stack, at least one current conductor connected to the electrode stack and a casing at least partially enclosing the electrode stack. The casing of the energy unit in turn comprises a plurality of edge sections on the peripheral narrow sides of the electrochemical cell, wherein at least part of the at least one current conductor protrudes from the casing at a first edge section and said first edge section of the casing comprises a substantially fluid-tight first sealing seam. The at least one frame element in the area of the casing's first edge section further comprises at least one first support web at a maximum distance of approximately 1 mm from the first sealing seam of the casing.

The invention also provides for an electrochemical energy storage apparatus, battery assembly respectively, having at least one such electrochemical cell.

According to the present invention, the at least one current conductor protrudes at least partially from the casing in a first edge section and the at least one frame element exhibits at least one support web in the area of the casing's first edge section distanced a maximum of approximately 1 mm from the casing's first sealing seam in its first edge section. Because of this first support web in the area of the casing's first edge section, the frame element prevents the sealing seam from rupturing or ripping open upon excess pressure inside the energy unit in the area of the current conductor (which often constitutes a weak point of sealing seams in conventional cells) and pressure relief can ensue solely by means of the pressure relief means specifically intended for the purpose (this process is also known as “venting”).

Providing a residual gap between the support web of the frame element and the sealing seam in said first edge section of the casing advantageously enables being able to insert different current conductors, particularly current conductors of differing thicknesses, into frame elements for electrochemical cells. In the context of the present invention, there is of course also the possibility of leading the support web of the frame element up to the sealing seam; i.e. at substantially no distance from the sealing seam.

Particularly in the case of lithium ion batteries for the automotive sector, there is the problem of cells additionally accommodating a battery management system and/or further electronic components in the area of the current conductors within the battery housing. In this context, the inventive electrochemical cell has the advantage that upon increased pressure and/or increased temperature within the interior of the energy unit, the pressure reduction and the material discharge ensues by means of the at least one pressure relief apparatus and not in the area of the current conductor or the battery management system. Doing so thus increases the operational reliability of the battery and the safety of the passengers in the event of a critical pressure or temperature situation within an electrochemical cell's energy unit. In particular, short circuits from electrically conductive venting gases and/or electrolytes can thereby also be prevented in the area of the current conductor.

To be understood by an “electrochemical energy storage apparatus” herein is any type of energy storage device from which electrical energy can be withdrawn, wherein an electrochemical reaction occurs within the interior of the energy storage device. The term encompasses energy storage devices of all types, particularly primary and secondary batteries. The electrochemical energy storage apparatus comprises at least one electrochemical cell, preferably a plurality of electrochemical cells. The plurality of electrochemical cells can be connected in parallel to store a greater charge or in series to obtain a desired operating voltage or can make use of a combination parallel/series connection.

An “electrochemical cell” or “electrochemical energy storage cell” herein refers to an apparatus serving in the discharge of electrical energy, wherein the energy is stored in chemical form. In the case of rechargeable secondary batteries, the cell is also designed to absorb electrical energy, convert it into chemical energy and store it. The form (i.e. the size and geometry particularly) of an electrochemical cell can be selected as a function of the space available for same. Preferably, the electrochemical cell is of substantially prismatic or cylindrical configuration. The present invention can in particular be advantageously applied to electrochemical cells known as pouch or coffee bag cells, without the electrochemical cell of the present invention being limited to such application.

In conjunction hereto, an “electrode stack” is to be understood as an arrangement of at least two electrodes with an electrolyte arranged therebetween. The electrolyte can be partly accommodated by a separator, wherein the separator then separates the electrodes. The electrode stack preferably exhibits a plurality of electrode and separator layers, wherein electrodes of the same polarity are preferably electrically interconnected in each, in particular connected in parallel. The electrodes are for example of plate or film-like configuration and are preferentially arranged substantially parallel to one another (prismatic energy storage cells). The electrode stack can also be wound and have a substantially cylindrical form (cylindrical energy storage cells). The term “electrode stack” is also to include such electrode coils. The electrode stack can comprise lithium or another alkali metal, also in ionic form.

A “current conductor” is to be understood in conjunction with the present invention as an electrically conductive structural element of an electrochemical cell serving in the transport of electrical energy to and from the cell. Electrochemical cells usually have two types of current conductors, each respectively in electrically conductive connection with one of the two electrodes or electrode groups—anodes and/or cathodes—in the interior of the cell. In other words, each electrode of the cell's electrode stack has its own current conductor and/or the electrodes of the electrode stack having the same polarity are connected to a common current conductor. The form of the current conductor is adapted to the form of the electrochemical cell, its electrode stack respectively.

The term “casing” is to encompass any type of apparatus suited to preventing chemicals leaking into the environment from the electrode stack and protecting the components of the electrode stack from harmful external influences. The casing can be configured from one or more formed parts and/or can be film-like. The casing can furthermore be composed of one or a plurality of layers. The casing can additionally be made from a substantially rigid material or flexible material. The casing is preferably made from a gas-tight and electrically insulating material or layered composite. The casing preferably encloses the electrode stack without gaps or air pockets to the greatest extent possible so as to enable good thermal conduction between the casing and the interior of the electrochemical cell.

The term “energy unit” in the present context refers to a self-contained assembly which realizes the properties of energy storage and energy discharge. The energy unit comprises in particular, albeit not necessarily exclusively, the electrode stack, the current conductor and the casing.

A “pressure relief means” in the context of the present invention refers to all types of apparatus which are suited to opening the casing under specific predefined conditions, particularly upon an increase in pressure or temperature within the electrochemical cell (e.g. due to overload or the like) so as to enable pressure relief with or without material discharge from the cell. It is expressly noted that the present invention is not limited to any specific type of pressure relief means. In the case of an electrochemical cell having two or more pressure relief means, they can be of the same type or can also differ from one another.

A “frame element” in the sense of the present invention refers to any structural apparatus which is suited to mechanically stabilizing an energy unit of an electrochemical cell. Such stabilizing is advantageous particularly, albeit not exclusively, during the manufacturing process of a battery assembly having a plurality of electrochemical cells. The term “frame element” is to particularly include those apparatus which substantially fully enclose an energy unit on its narrow sides (corresponding to a frame in the conventional sense) as well as apparatus which supports an energy unit only on one narrow side, a portion of the narrow sides or a portion of one or more of the narrow sides (corresponding to one arm of a frame or a frame arm assembly). The at least one frame element can preferably be of one-piece or multi-piece configuration. Frame elements are further conceivable which only support an energy unit on one main side (single-sided) or which support an energy unit on both of its two main sides (double-sided).

An energy unit's four peripheral narrow sides are regarded sectionally in conjunction with the present invention (the casing “edge sections”). A first edge section of the casing is defined in the area of the at least one current conductor; i.e. a casing normally has two first edge sections for the two current conductors to the negative terminal and the positive terminal.

A “sealing seam” in the sense of the present invention refers to a fluid-tight (i.e. fluid and gas-tight) connection of a section of the casing to another component (e.g. particularly a further section of the casing or a current conductor). The casing preferably has a material and/or a material layer at its connection side which is at least partially melted and can be joined under pressure (so-called heat sealing).

In conjunction with the present invention, the term “support web” is to denote any structural element attached to and/or provided on the frame element and extending toward an edge section of the casing. The support web is preferably suited to contacting an edge section of the casing or a sealing seam provided on same without damaging or degrading same. To this end, the support web can advantageously be coated, treated or provided with an additional element on its side facing the respective casing edge section. The support web is preferably configured and disposed such that it fixes or at least limits the position of the casing in the respective edge section or supports the sealing seam of the casing respectively. The supportive effect of the at least one frame element's support web preferably prevents the sealing seam from fissuring due to peeling stress occurring upon excess pressure within the energy unit.

Preferred further developments of the invention will now be described in the following.

The at least one first support web of the at least one frame element is preferably distanced at a maximum of approximately 0.75 mm, more preferentially at a maximum of approximately 0.5 mm, and even more preferentially at a maximum of approximately 0.3 mm from the first sealing seam of the casing.

The at least one first support web of the at least one frame element preferably has a width in the transverse direction to the first edge section of at least approximately 1.5 mm, more preferentially of at least approximately 2.5 mm, and even more preferentially of at least approximately 3 mm. Doing so provides a sufficiently large enough supporting or boundary surface for the first sealing seam on the first edge section of the casing.

In a preferred embodiment, the at least one pressure relief means exhibits a weakening to at least one further substantially fluid-tight sealing seam of the casing or at least one further section of the casing, wherein this further sealing seam or this further casing section respectively is provided in a further edge section of the casing differing from the at least one first edge section. Such a weakening of a further sealing seam or a further part of the casing respectively induces the casing to burst/rupture/break open at this point when excess pressure develops in the interior of the energy unit.

A “weakening” to a sealing seam or section of the casing can advantageously be obtained by a localized weakening in the material or the material structure, by a specific shape to the casing at said point, by incorporating additional elements with specific physical and/or chemical properties (e.g. lower melting point, etc.) into the material or material structure or by the sealing seam having a lower strength at said point.

In a further preferred embodiment of the invention, the at least one pressure relief means additionally or alternatively exhibits a recess in the at least one frame element, wherein said recess is provided in the area of one a further edge section of the casing differing from the at least one first edge section, and the frame element in the area of said recess is distanced from a further sealing seam or further section of the casing. Such a recess in the frame element allows the casing or the casing material to give way upon excess pressure developing within the energy unit so that it is easier for the casing, or a sealing seam respectively, to burst/rupture/break open at this point.

The at least one pressure relief means preferably comprises a weakening in the further sealing seam(s) or casing section, respectively, and a recess in the frame element. The recess in the at least one frame element is then preferably substantially disposed in the area of the weakening of the further sealing seam of the casing or the further casing section.

In this embodiment, the weakening to the further sealing seam of the casing, the further section of the casing respectively, measures at least as large in the longitudinal direction of the further casing edge section as the recess in the at least one frame element.

In a further preferred embodiment of the invention, at least one opening means to open the further sealing seam of the casing or the further casing edge section to reduce pressure is additionally provided in the recess of the frame element. The term “opening means” thereby encompasses all structural elements which support an opening/breaking open/bursting/rupturing of the further sealing seam or the further casing section respectively in the area of the frame element recess. The opening means preferably has one or more teeth, mandrels, blades, cutting elements or the like.

The above-clarified embodiments of the at least one pressure relief means allow a controlled venting at a specific point on the casing beyond the area of the current conductor.

In a preferred embodiment of the invention, the at least one frame element exhibits at least one further support web in the area outside of the first casing edge section which at least partially abuts a further sealing seam of the casing or a further section of the casing. In this embodiment of the electrochemical cell, the casing or its sealing seams respectively are not only supported in the area of the first edge section near the current conductors but also at other points in order to prevent an undesired breaking open/bursting/rupturing there when excess pressure develops in the interior of the energy unit and to achieve a controlled venting exclusively at the at least one pressure relief apparatus.

In a further preferred embodiment of the invention, the at least one pressure relief means is arranged on a narrow side of the electrochemical cell disposed opposite the first edge section of the casing. Doing so enables the pressure relief to transpire at a (farthest possible) distance from the current conductors when excess pressure develops inside the energy unit.

In a preferred embodiment, the entire sealing seam on the further edge section of the casing disposed on the narrow side opposite the first edge section, the current conductor respectively, can be provided with a weakening as described above. In a further preferred embodiment, the sealing seams on further edge sections of the casing disposed on the narrow sides of the energy unit running transversely to the first edge section can additionally be completely or partially provided with such a weakening.

In a further preferred embodiment of the invention, the at least one pressure relief means is arranged on a narrow side of the electrochemical cell which is essentially at the bottom when the electrochemical cell is installed. Doing so enables the pressure relief to transpire downward upon excess pressure developing within the energy unit and not, for example, toward a motor vehicle's passenger compartment under which the battery assembly with the electrochemical cell(s) is disposed.

If a plurality of such electrochemical cells are provided in an electrochemical energy storage apparatus, a stack of alternating arranged energy units and frame elements is preferably provided such that each energy unit is held between two frame elements and each frame element is associated with two adjacent energy units. This enables the total number of frame elements required for the plurality of electrochemical cells to be reduced. Using both sides of the frame elements naturally only applies within the stack and is no longer applicable at the edge of the stack, at least in the case of the outermost frame element. To use both sides of the frame elements, same are preferably of substantially symmetrical configuration in the stacking direction. In conjunction hereto, the double-sided use of the frame elements can apply to all or only some of the electrochemical cells within the stack.

Further advantages, features and application possibilities of the present invention will be evident from the following description of preferred embodiments coupled with the drawings, which show:

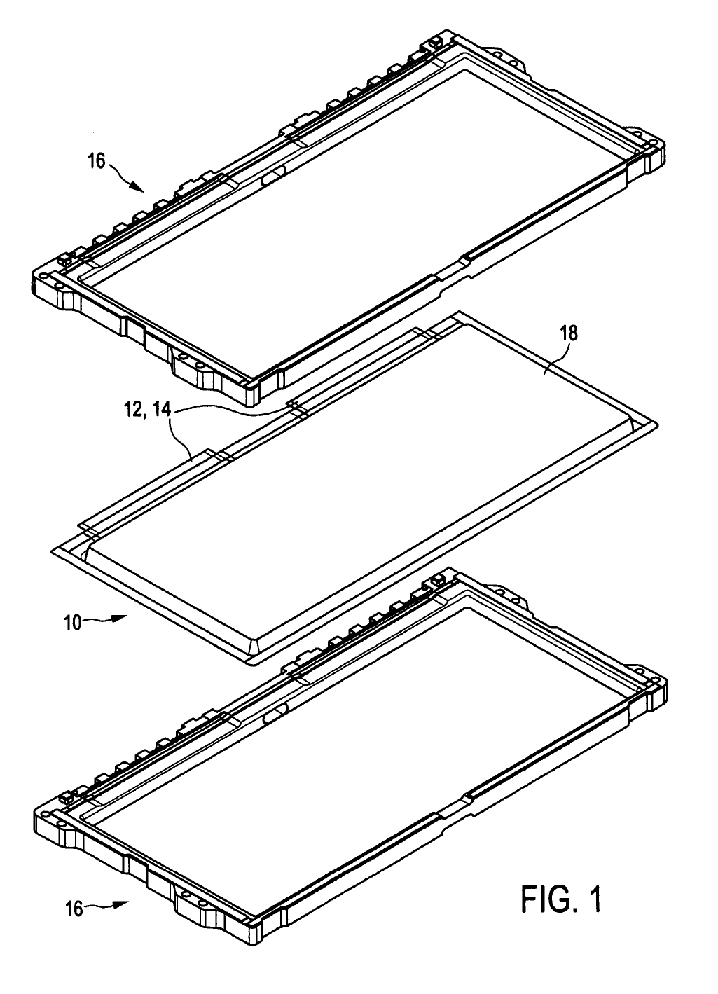

FIG. 1 a schematic perspective exploded view of an electrochemical cell in accordance with an embodiment of the present invention;

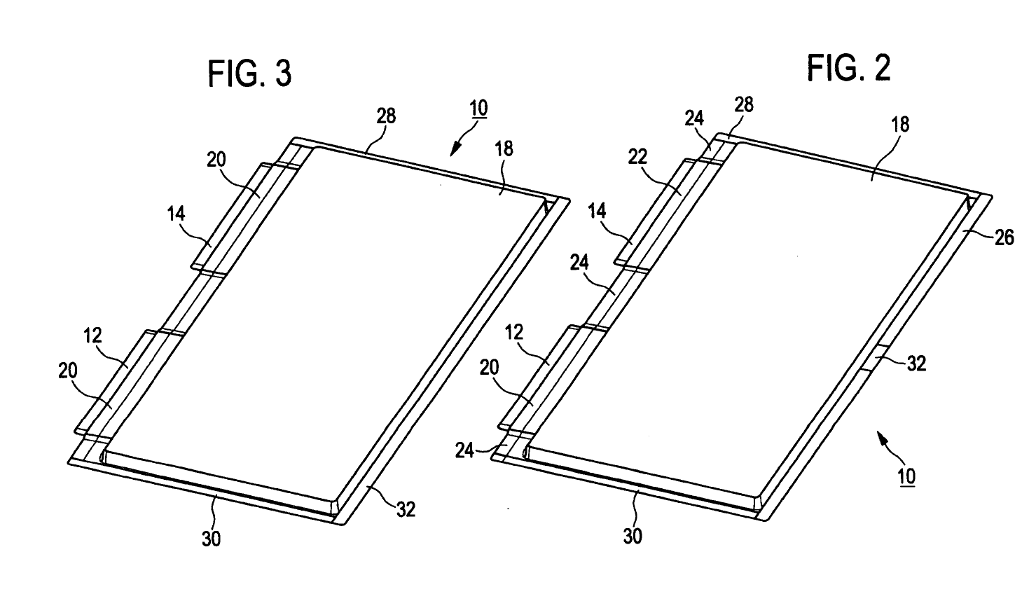

FIG. 2 a schematic perspective view of a first preferred embodiment of an energy unit for an electrochemical cell in accordance with the present invention;

FIG. 3 a schematic perspective view of a second preferred embodiment of an energy unit for an electrochemical cell in accordance with the present invention;

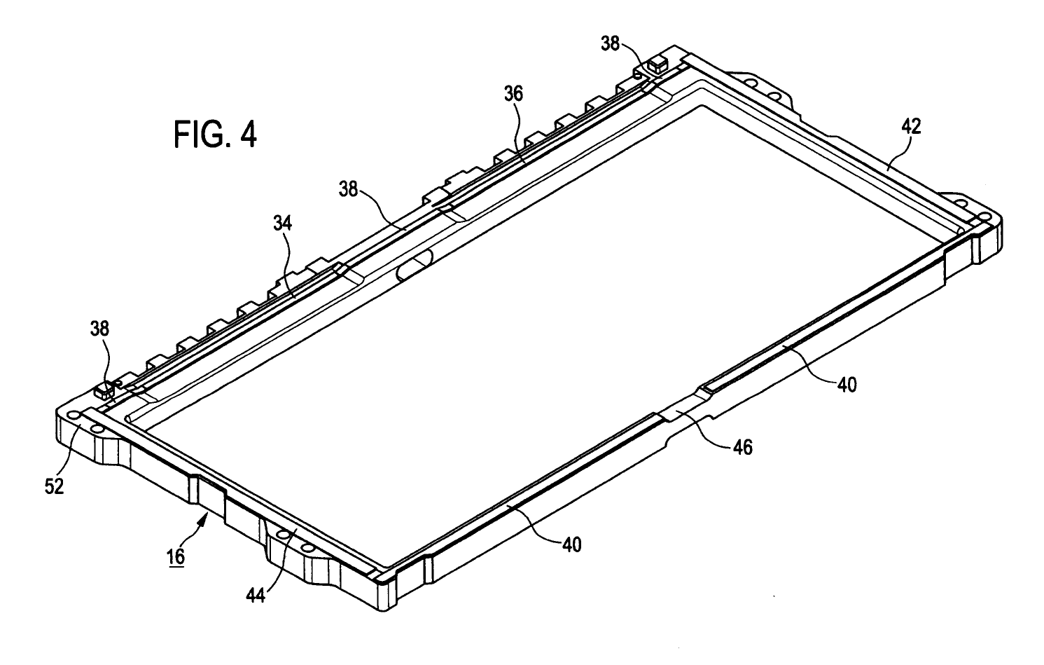

FIG. 4 a schematic perspective view of a preferred embodiment of a frame element for an electrochemical cell in accordance with the present invention;

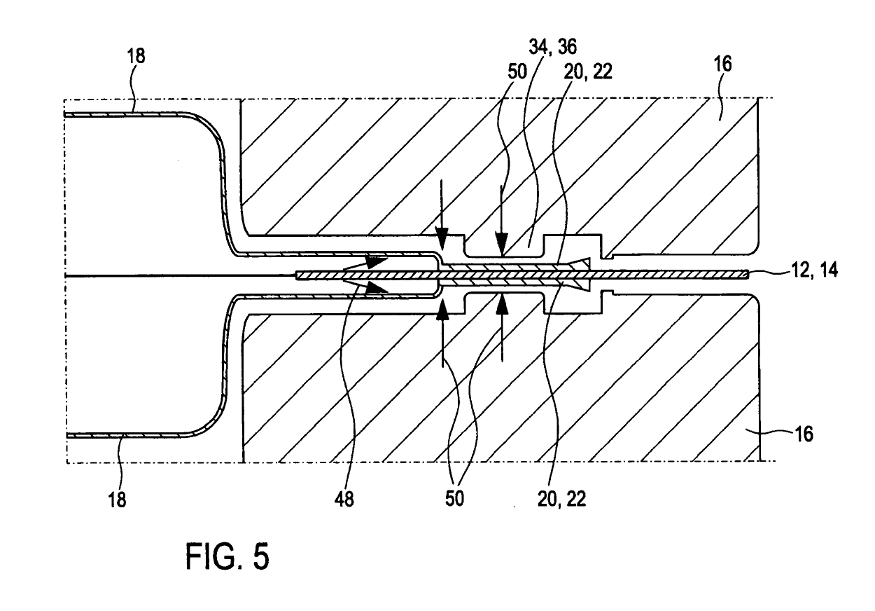

FIG. 5 a schematic partly sectional view of an electrochemical cell in accordance with the present invention to illustrate the inventive mode of operation; and

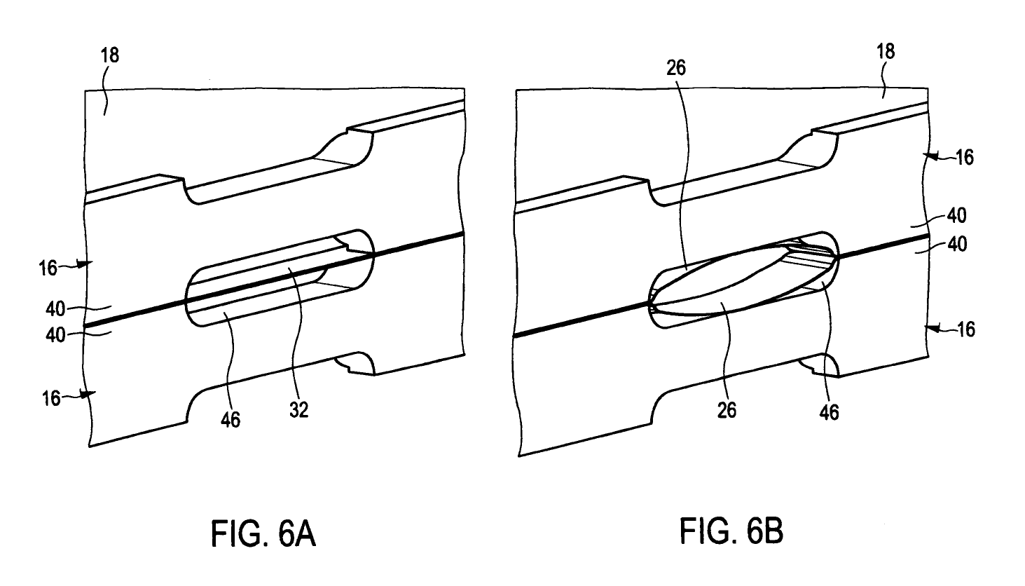

FIG. 6 schematic partially perspective views of an electrochemical cell in accordance with the present invention to illustrate the inventive mode of operation.

FIG. 1 shows an exploded view of an electrochemical cell comprising an energy unit 10 and two frame elements 16, wherein said two frame elements 16 of two respective adjacent energy units 10 in one stack can be associated with a plurality of electrochemical cells within a battery assembly.

The energy unit 10 constitutes a uniform structural unit and contains an electrode stack (not shown), a first current conductor 12 connected to the electrode stack anode, a second current conductor 14 connected to the electrode stack cathode, and a casing 18 enclosing the electrode stack, for example in the form of a multi-layer film. The two current conductors 12, 14 partially protrude from the casing 18 of the energy unit 10 so as to be able to be contacted from the outside.

In this embodiment, the energy unit 10 is wholly supported at its four narrow sides between the two frame elements 16. Multi-part frame elements are also alternatively conceivable, as are frame elements which only support the energy unit over a portion of its periphery.

FIGS. 2 and 3 show two possible embodiments of an energy unit for such an electrochemical cell.

In each of the present embodiments, the casing 18 is composed of two substantially congruent casing sections connected together, sealed in particular, with the electrode stack between them so as to be fluid-tight (i.e. liquid and gas-tight) such that a peripheral sealing seam is formed. In alternative embodiments, the casing 18 can also be configured from one casing section which is folded and sealed such that a sealing seam is eliminated on at least one narrow side of the energy unit 10.

The casing 18 exhibits a plurality of edge sections along the four narrow sides of the energy unit 10 which altogether extend completely around the energy unit 10. Correspondingly, the peripheral sealing seam can (theoretically) also be divided into a plurality of sealing seams. A first sealing seam 20 or 22 is provided in each of the two first edge sections of the casing 18 in which the two current conductors 12, 14 protrude from the casing. A plurality of second sealing seams 24 are defined on the edge sections of the casing 18 situated outside of the first edge section on the same narrow side of the energy unit 10 as those sections.

A third sealing seam 26 is formed on the edge section of the casing 18 on the narrow side of the energy unit 10 opposite the first edge sections (on the right in FIGS. 2 and 3). A fourth and fifth sealing seam 28 and 30 are situated on the edge sections of the casing 18 on the narrow sides of the energy unit running transverse to the narrow sides with the current conductors 12, 14 (above/below in FIGS. 2 and 3).

In the FIG. 2 embodiment, the third sealing seam 26 of casing 18 exhibits a weakening 32 extending over a partial section of the corresponding narrow side of the energy unit 10.

In the FIG. 3 embodiment, on the other hand, the third sealing seam 26 of casing 18 exhibits a weakening 32 extending substantially over the entire narrow side of the energy unit 10.

In other embodiments of the electrochemical cell, a plurality of weakenings 32 can be provided in the third sealing seam 26 and/or the fourth and/or fifth sealing seam 28, 30 can exhibit one or a plurality of weakenings. Should there be no sealing seam 26 provided on the narrow side of the energy unit 10 opposite the first edge sections of the casing 18, but instead a section of the casing is folded over, the cited weakenings 32 are accordingly provided in such a casing section.

FIG. 3 shows a frame element 16 of the electrochemical cell from FIG. 1 in greater detail.

The frame element 16 of this embodiment consists of four one-part or multi-part frame arms such that it completely encloses the four narrow sides of the energy unit 10 and can support the respective edge sections of the casing 18 there.

As FIG. 3 shows, the frame element 16 is formed with a plurality of support webs 34 to 44 extending from the side of the frame element 16 toward the edge sections of the casing 18 of the adjacent energy unit 10. The frame element 16 likewise exhibits these support webs 34 to 44 on the inverted side not visible in FIG. 3. The frame element 16 is thus of substantially symmetrical configuration in the stacking direction of a plurality of electrochemical cells. The support webs 34 to 44 are for example molded onto the frame element 16 or formed as separate components and fixedly connected to the frame element 16.

The supports webs 34 to 44 of the frame element 16 are affixed to the frame element 16 in correspondence with the edge sections of the casing 18. In particular, a first support web 34 is arranged in the area of the first sealing seam 20 in the first edge section at which the first current conductor 12 extends from the casing 18 and a first support web 36 is arranged in the area of the first sealing seam 22 in the first edge section at which the second current conductor 14 extends from the casing 18. Second support webs 38 are further disposed in the area of the second sealing seams 24, a third support web 40 is disposed in the area of the third sealing seam 26, a fourth support web 42 is disposed in the area of the fourth sealing seam 28 and a fifth support web 44 is disposed in the area of the fifth sealing seam 30 of casing 18.

The first to fifth support webs 34 to 44 are provided along virtually the entire four narrow sides of the energy unit 10 on the frame element 16. The support webs 34 to 44 have different widths in this embodiment (transverse to their respective longitudinal direction), although can also be dimensioned to be substantially identical to one another. The width of the support webs 34 to 44 in the transverse direction to the respective edge section amounts to at least approximately 1.5 mm, preferentially at least approximately 2.5 mm, and even more preferentially at least approximately 3 mm, in order to provide sufficient support to the sealing seams 20 to 30.

Whereas the second to fifth support webs 38 to 44 respectively extend to the second through fifth sealing seams 24 to 30 when the electrochemical cell is assembled; i.e. when the frame element 16 retains or supports the energy unit 10, the first support webs 34 and 36 are of weaker configuration so that they are distanced from the first sealing seams 20/22 on the current conductors 12/14.

FIG. 5 illustrates this for the first support webs 34, 36 at the first sealing seams 20, 22. It can be seen in particular from FIG. 4 that the current conductor 12, 14 connected to the electrode stack leads out from the casing 18. Each first edge section of the casing 18 is connected in fluid-tight manner to the current conductor 12, 14 by means of a sealing seam 20, 22.

When excess pressure develops within the cell or the energy unit 10 respectively, said excess pressure produces peeling force or stress in the area of the weak points in casing 18 depicted in FIG. 5 (see arrow 48) which attempt to pull the edge sections of the casing 18 apart and away from the current conductors 12, 14. The above-described first support webs 34, 36 on the frame element 16, which are not found on comparable frame elements of conventional electrochemical cells, counteract this rupturing/pulling apart of the first sealing seams 20, 22. As illustrated by arrow 50 in FIG. 5, the first support webs 34, 36 of the frame element 16 limit the possibility of the first edge sections of the casing 18 giving way and thereby support the first sealing seams 20, 22. Doing so thus effectively prevents the casing 18, the sealing seam 20, 22 respectively, from pulling apart in the area of the current conductors 12, 14, and the venting gas escaping at that point, upon excess pressure within the energy unit 10.

Going back to FIG. 4 again, it can be seen that the frame element 16 further comprises a recess 46 on its frame arm configured with the third support web 40. Said recess 46 substantially corresponds to the absence of the third support web 40 in a partial section. This recess 46 is furthermore positioned in correspondence with the weakening 32 of the third sealing seam 26 of the casing 18 in FIG. 2 or on any given, preferably central point corresponding to the weakening 32 of the third sealing seam 26 of the casing 18 in FIG. 3.

The recess 46 of the frame element 16 and the weakening 32 of the third sealing seam 26 together form a pressure relief apparatus for the electrochemical cell.

As FIG. 6A illustrates, in the cell's normal state (i.e. in particular without excess pressure within the cell), the frame element 16 is distanced from the third sealing seam 26 with weakening 32 in the area of its recess 46. In contrast, additionally to the recess 46, the third support webs 40 of two adjacent frame elements 16 abut the sealing seam 26 of the casing 18 of the interjacently accommodated energy unit 10 and thus hold it together.

Should excess pressure develop within the interior of the energy unit 10, this excess pressure is exclusively withdrawn from the current conductors 12, 14 of the energy unit 10 in the inventive electrochemical cell by means of the pressure relief apparatus 32, 46 and channeled to the greatest extent possible to the lower area of the electrochemical cell. As FIG. 6B depicts, the excess pressure within the energy unit 10 produces peeling stress at the sealing seams 20 to 30 of the casing 18 which rupture the third sealing seam 26 in the area of the recess 46 of frame element 16.

The weakening 32 of the third sealing seam 26 ensures that at least in this area, the sealing seam of the casing will rupture first in the pressure relief apparatus upon excess pressure within energy unit 10 near the current conductors 12, 14, also when the first support webs 34, 36 are distanced from the first sealing seams 20, 22.

To increase the mechanical stability of an electrochemical cell and in particular a stack of a plurality of electrochemical cells for a battery assembly, the frame elements 16 are preferably furthermore configured with fixing apparatus 52 (see FIG. 4) with which two adjacent frame elements 16 or all frame elements 16 of a cell stack can be aligned and/or fixedly connected to one another (e.g. by means of screws, rivets, clamping pins or the like). This connection is moreover also advantageous with respect to the supportive effect of the support webs 34-44 against the sealing seams 20-30 of the casing 18.

1. An electrochemical cell comprising:
an energy unit including an electrode stack, at least one current conductor connected to the electrode stack and a casing at least partially enclosing the electrode stack;
at least one frame element at least partially accommodating the energy unit; and
at least one pressure relief means for reducing excess pressure within the energy unit,
wherein the casing of the energy unit comprises a plurality of edge sections on the peripheral narrow sides of the electrochemical cell, wherein the at least one current conductor protrudes at least partially from the casing at a first edge section and said first edge section of the casing comprises a substantially fluid-tight first sealing seam,
wherein the at least one frame element in an area of the first edge section of the casing further comprises at least one first support web at a maximum distance of 1 mm from the first sealing seam of the casing, and
wherein said at least one pressure relief means is arranged on a narrow side of said electrochemical cell that is disposed opposite said first edge section of said casing.

2. The electrochemical cell according to claim 1, wherein the at least one first support web of the at least one frame element is distanced at a maximum of 0.75 mm from the first sealing seam of the casing.

3. The electrochemical cell according to claim 1, wherein the at least one first support web of the at least one frame element has a width in a transverse direction with respect to the first edge section of at least 1.5 mm.

4. The electrochemical cell according to claim 1, wherein the at least one pressure relief means includes a weakening of a further substantially fluid-tight sealing seam of the casing (18) or a further casing section, wherein the further substantially fluid-tight sealing seam or the further casing section respectively is provided in a further edge section of the casing differing from the at least one first edge section.

5. The electrochemical cell according to claim 1, wherein the at least one pressure relief means includes a recess in the at least one frame element, wherein said recess is provided in an area of a further edge section of the casing differing from the at least one first edge section and the frame element in an area of said recess (46) is distanced from a further sealing seam of the casing or a further casing section.

6. The electrochemical cell according to claim 4, wherein the recess in the at least one frame element is substantially disposed in the area of the weakening of the further sealing seam of the casing or the further casing section.

7. The electrochemical cell according to claim 6, wherein the weakening of the further sealing seam of the casing or the further casing section measures at least as large in a longitudinal direction of the further edge section of the casing as the recess in the at least one frame element.

8. The electrochemical cell according to claim 5, further comprising:
at least one opening means provided in the recess of the frame element to open the further sealing seam of the casing or the further casing section.

9. The electrochemical cell according to claim 8, wherein the at least one frame element comprises at least one further support web in the area outside of the first edge section of the casing, the at least one further support web at least partially abutting a further sealing seam of the casing or a further casing section.

10. (canceled)

11. The electrochemical cell according to claim 9, wherein the at least one pressure relief means is arranged on a narrow side of the electrochemical cell which is disposed at a bottom when the electrochemical cell is installed.

12. An electrochemical energy storage apparatus comprising at least one electrochemical cell comprising:
an energy unit including an electrode stack, at least one current conductor connected to said electrode stack and a casing at least partially enclosing said electrode stack;
at least one frame element at least partially accommodating said energy unit; and
at least one pressure relief means for reducing excess pressure within said energy unit,
wherein said casing of said energy unit comprises a plurality of edge sections on the peripheral narrow sides of the electrochemical cell, wherein said at least one current conductor protrudes at least partially from said casing at a first edge section and said first edge section of said casing comprises a substantially fluid-tight sealing seam, wherein said at least one frame element in an area of said first edge section of said casing further comprises at least one first support web being arranged at a maximum distance of 1 mm from said first fluid-tight sealing seam of said casing, and wherein said at least one pressure relief means is arranged on a narrow side of said electrochemical cell that is disposed opposite said first edge section of said casing.

13. The electrochemical energy storage apparatus according to claim 12, further comprising:
a plurality of electrochemical cells, wherein a stack of alternatingly arranged energy units and frame elements is provided such that each energy unit is held between two frame elements and each frame element is associated with two adjacent energy units.

14. The electrochemical cell according to claim 2, wherein the at least one first support web of the at least one frame element is distanced at a maximum of 0.5 mm from the first sealing seam of the casing.

15. The electrochemical cell according to claim 14, wherein the at least one first support web of the at least one frame element is distanced at a maximum of 0.3 mm from the first sealing seam of the casing.

16. The electrochemical cell according to claim 3, wherein the at least one first support web of the at least one frame element has a width in the transverse direction with respect to the first edge section of at least 2.5 mm.

17. The electrochemical cell according to claim 16, wherein the at least one first support web of the at least one frame element has a width in the transverse direction with respect to the first edge section of at least 3 mm.
